(19) United States
(12) Patent Application Publication
(10) Pub. No.: US 2013/0157233 A1
(43) Pub. Date: Jun. 20, 2013

(54) METHODS AND SYSTEMS FOR PREPARING A CUSTOMIZED HEALTH CONDITION-SPECIFIC PERSONAL EATING PLAN

(71) Applicant: Kevin LEVILLE, New Canaan, CT (US)

(72) Inventor: Kevin LEVILLE, New Canaan, CT (US)

(21) Appl. No.: 13/710,010

(22) Filed: Dec. 10, 2012

Related U.S. Application Data
(60) Provisional application No. 61/569,638, filed on Dec. 12, 2011.

(51) Int. Cl. G09B 19/00

(52) U.S. Cl. CPC G09B 19/0092
USPC 434/127

(57) ABSTRACT

The present invention relates to methods and systems for preparing a health condition-specific eating plan for a subject that is based on personal healthcare information from the subject. The personal healthcare information from the subject is used to identify the preexistence of one or more health conditions, as well as the risk for developing health conditions in the future. This information is then used to generate a list of foods that are beneficial for treating the health condition(s) if incorporated into the subject's eating plan. The customized selection of foods is based on the phytochemical content and density of the foods.

### CROSS-REFERENCE TO RELATED APPLICATIONS

This application is a continuation of U.S. Provisional Patent Application No. 61/569,638 entitled “Methods and Systems for Preparing a Customized Health Condition-Specific Personal Eating Plan” and filed Dec. 12, 2011, the contents of which are incorporated herein in their entirety.

### FIELD OF INVENTION

The present invention relates to methods and systems for preparing a health condition-specific eating plan for a subject that is based on personal healthcare information from the subject. The personal healthcare information from the subject is used to identify the preexistence of one or more health conditions, as well as the risk for developing health conditions in the future. This information is then used to generate a list of foods that are beneficial for treating the health condition(s) if incorporated into the subject's eating plan. The customized selection of foods is based on the phytochemical content and density of the foods.

### BACKGROUND OF THE INVENTION

Numerous nutritional programs have been offered to the public over the years to address health conditions, such as obesity, diabetes, etc. Most of these programs rely on limiting food intake based on one or more criteria (e.g., calories, carbohydrates, fat, etc.) For example, the Atkins diet (Atkins Nutritionals, Inc.) focuses on severely limiting carbohydrate intake. However, this type of restrictive diet can have a variety of dangerous side effects, such as an increased risk of heart disease due to a high fat intake.

Another diet program, the South Beach Diet™ (www.southbeachdiet.com), is based on a characterization of carbohydrates, fats and proteins as being “good” or “bad”. While being more balanced than a program based on a single criteria (e.g., calories), it is still very restrictive and does not have a good compliance rate.

The Zone Diet (Zone Labs, Inc., Danvers, Mass.), in comparison, is based on characterizing food in terms of protein, fat and carbohydrate content, and selecting food on the basis of the relative amounts of these three substances. Again, this diet is more balanced and has a satisfactory compliance rate, but it is still somewhat difficult to follow since it relies heavily on the dieter being capable of estimating what foods to select and how to incorporate the diet into daily and long term programs.

Other types of diet programs rely on the use of appetite suppressants, which are usually stimulants that are not well tolerated by individuals with high blood pressure or other medical conditions that are often associated with obesity. Still other diet programs are based on strict dietary intake by supplying prepackaged food, or are based on behavior modification in a support group setting.

More recently, nutritional programs have been described based on “nutrient density”, which is a term that is unfortunately used inconsistently in the industry, and may be based on calories/nutrients, nutrients/calories, or nutrients/nutrients (Am. J. Clin. Nutr. 82:721-732 (2005). One such a program is the online Nutripoints diet program that classifies foods into six food groups, and scores foods based on their “nutritional value” (www.nutripoints.com, Nutripoints, Inc., Carlsbad, Calif.).

Two such nutrition programs are the ANDI food scoring system (Whole Foods, Austin, Tex.) and the NuVal food scoring system (NuVal, Braintree, Mass.). However, such programs are limited in that they only consider micro- and macro-nutrients, and they do not focus on phytochemicals. Accordingly, they are unable to specifically address particular health conditions in the most efficient manner.

In addition to the aforementioned nutritional programs designed to promote and maintain weight loss, the same principles of nutritional control can be applied to other disease states, such as diabetes, heart disease and hypertension. For example, nutritional programs designed to assist individuals suffering from diabetes are well known and often involve a combination of controlling the intake of specific nutrients, as well as sugar. In another example, nutritional programs to prevent cancer are known to focus on increasing ingestion of anti-oxidants and other vitamins, such as vitamins C and E.

Accordingly, there is a need in the art for a nutritional program that includes a customized eating plan that simultaneously addresses a health condition (or risk of developing a health condition), improves dietary nutrition, and alters eating habits to promote good health.

### SUMMARY OF THE INVENTION

The present invention relates to methods and systems for preparing a health condition-specific eating plan for a subject that is based on personal healthcare information from the subject. The personal healthcare information from the subject is used to identify the preexistence of one or more health conditions, as well as the risk for developing health conditions in the future. This information is then used to generate a list of foods that are beneficial for treating the health condition(s) if incorporated into the subject's eating plan. The customized selection of foods is based on the phytochemical content and density of the foods.

Accordingly, in one embodiment the invention is a computer-implemented method for preparing a health condition-specific personal eating plan for a subject based on phytochemical content and density of foods. The method includes the steps of 1) preprogramming the computer with: a list of phytochemicals that are known to be beneficial for treating the health condition; a list of foods known to contain the phytochemicals at a given density; and the density of those phytochemicals in the foods; 2) obtaining data from the subject, wherein the data comprises personal healthcare information and eating behaviors; 3) processing the data to determine if the subject has one or more existing health conditions or a risk for developing one or more health conditions; and 4) generating a health condition-specific list of foods to incorporate into the subject's personal eating plan that is customized for the subject based on their health condition or conditions, or risk of developing the health condition or conditions; wherein the health condition-specific list of foods is based on the phytochemical content and density of the foods.

The foods that are included on the generated list of foods may be unprocessed plant-based food.

In one embodiment, the foods are selected for inclusion on the list of foods without considering their caloric value.

In another embodiment, if the computer determines that the subject has a risk of developing a health condition in the future, then the risk is ranked, such as low risk, medium risk or high risk.

In addition, the foods included on the list of foods may be ranked based on their phytochemical density.

In an embodiment that is particularly well suited for individuals with diabetes or with a risk of developing diabetes, the foods selected by the computer for the list of foods may also take into consideration the glycemic index of the food, and in some instances may exclude foods based on a glycemic index that is too high.

The food may also be categorized in the list of foods by food groups, such as vegetables, colorful vegetables, fruits, nuts & seeds, beans, and whole grains & starchy vegetables.

The list of foods may also include portion sizes for each of the foods on the list.

The method of the present invention may also include generating a daily or weekly intake plan for the subject that includes serving numbers to ingest in each of the food groups and or recipes that include the foods on the list of foods.

In another embodiment, a method for preparing a health condition-specific personal eating plan for a subject based on phytochemical content and density of foods includes providing the subject with a list of phytochemicals that are known to be beneficial for treating the health condition. The subject is also provided with a list of foods known to contain the phytochemicals at a given density. Personal healthcare information and eating behaviors of the subject are analyzed to determine if the subject has one or more existing health conditions or a risk for developing one or more health conditions. This information is used to generate a health condition-specific list of foods to incorporate into the subject's personal eating plan that is customized for the subject based on their health condition or conditions, or risk of developing the health condition or conditions. The subject then consumes at least one food on the health condition-specific list of foods based on the phytochemical content and density of the foods.

Other aspects of the invention are found throughout the specification.

### DETAILED DESCRIPTION OF THE INVENTION

The present invention relates to methods and systems for preparing a health condition-specific eating plan for a subject that is based on personal healthcare information from the subject. The personal healthcare information from the subject is used to identify the preexistence of one or more health conditions, as well as the risk for developing health conditions in the future. This information is then used to generate a list of foods that are beneficial for treating the health condition(s) if incorporated into the subject's eating plan. The customized selection of foods is based, in part, on the phytochemical content and density of the foods.

It is to be understood that the methods and systems of the present invention do not involve the selection of foods based on calories. In one embodiment, the foods that are selected by the method of the present invention are unprocessed, plant-based foods. Since such foods are less “energy dense” (i.e., they contain less calories per weight) than processed, packaged and refined food items, calories are not as important in the treatment of most health conditions.

When the terms “one,” “a,” or “an” are used in this disclosure, they mean “at least one” or “one or more,” unless otherwise indicated.

The term “phytochemical” as used herein refers to dietary compounds or chemicals found in or derived primarily from plants that provide a health benefit when consumed by humans or animals.

The term “treating” as used herein refers generally to addressing, preventing, treating, arresting, ameliorating, and/or curing a health condition.

The term “computer implemented” as used herein refers to a method practiced on a personal computer, a smart phone, a personal digital assistant (PDA) device (which is also a type of computer), or a server at a remote location that is accessible over the internet (wireless, dial-up, etc.) by a personal computer, smart phone or PDA device.

Phytochemicals

Phytochemicals are mainly found in plant-based foods. They are the chemicals that give plants their color and taste. One exemplary source of phytochemicals is plant-based whole foods (as opposed to processed foods), although phytochemicals are also present in processed foods and non-plant-based foods, such as eggs. Many phytochemicals are known to be beneficial in the treatment of various healthcare conditions.

Phytochemicals work by various mechanisms. They activate enzymes that can inactivate carcinogens; they suppress the growth and division of cancer cells; they activate hormones; they prevent bacteria and pathogens from binding to cell walls; they regulate DNA synthesis; and, as antioxidants, they act to disable potential cancer-causing cells. Heart health seems to respond to antioxidant action. The effects on osteoporosis, kidney disease, and other chronic diseases have also been reported.

A list of exemplary phytochemicals and their association with various healthcare conditions, as well as exemplary food sources, are shown below.

Beta carotene reduces blood pressure and inhibits lipid oxidation. It is converted in the body to Vitamin A. It has been reported to be beneficial in the treatment of diabetes and hypertension. In addition, beta-carotene is used to decrease asthma symptoms caused by exercise; to prevent certain cancers, heart disease, cataracts, and age related macular degeneration (AMD); and to treat AIDS, alcoholism, Alzheimer's disease, depression, epilepsy, headache, heartburn, high blood pressure, infertility, Parkinson's disease, rheumatoid arthritis, schizophrenia, and skin disorders including psoriasis and vitiligo. Beta carotene is found in kale and other dark green leafy vegetables, carrots, sweet potatoes, broccoli, winter squash and cantaloupe.

Lycopene is an important intermediate in the biosynthesis of beta carotene. It is bright red in color and has good anti-oxidant properties. Lycopene has been reported to have anticancer properties, to prevent the effects of skin aging due to ultraviolet light exposure, to inhibit the development of cataracts, and to be beneficial in the treatment of heart disease. Lycopene is found in tomatoes, watermelon, guava, and other red fruits and vegetables.

Zeaxanthin is associated with good eye health, and also has been reported to have a beneficial effect on hypertension and diabetes. Zeaxanthin is found in bell peppers, corn, saffron, carrots, collard greens and kale.

Cyanidin has anti-oxidant and free radical scavenging effects. As such, it has been reported to be beneficial in treating cardiovascular disease, cancer, obesity, diabetes and a variety of inflammatory conditions. Cyanidin is found in kale, swiss chard, romaine lettuce, corn, and various fruits such as oranges.

Quercitin has been reported to protect against allergies, hay fever and hives because of its ability to prevent histamine release. It is also reported to have anticancer properties, as well as a beneficial effect on diabetes and heart disease. Quercitin is found in citrus fruits, apples, onions, parsley, sage, dark berries.

Isorhamnetin is a metabolite of quercitin. It has been reported to be useful in the treatment of diabetes. Isorhamnetin is found in red turnips.

Lutein is an antioxidant, and has been reported to protect the retina against the harmful effects of certain types of light exposure. It has also been associated with lowering blood pressure. Lutein is found in egg yolks, peas and green leafy vegetables such as spinach, leaks and kale.

Indole has been reported to protect against estrogen-induced cancer cell growth and converts estrogen to a safer form. Indole is found in the broccoli family and kale.

Butyl Phthalide acts as an anti-tumor agent (it reduces the incidence of tumors), reduces blood pressure and lowers cholesterol. Butyl phthalide is found in celery.

Myricetin has been associated with a reduced risk of cancers, such as prostate and pancreatic cancer. It has also been associated with a reduced risk for developing diabetes. Myricetin is found in grapes, berries and walnuts.

Phytosterols have proven cholesterol-lowering properties. They compete with cholesterol for absorption in the intestines. As such, they are beneficial in the treatment of hypertension. They have also been reported to be beneficial in the treatment of cancer. Phytosterols are found in whole grains, nuts and legumes.

Resveratrol has been reported to have anticancer, anti-inflammatory and blood sugar lowering properties. Resveratol is found in grapes, peanuts, and deep colored berries.

Retinol, or Vitamim A, is known to be related to bone growth, vision and skin health. It is also reported to be beneficial in the treatment of diabetes. Retinol can be found in eggs and liver.

Other phytochemcials include, for example, apigenin (antioxidant, anticancer, anti-inflammatory), beta sitosterol (reduces cholesterol), theobromine (dilates blood vessels), theophylline (lowers blood pressure), coumarin (increases blood flow, decreases capillary permeability), scopo(etin (regulates blood pressure), allicin (relaxes blood vessels, normalizes heart rhythms), and sulforaphane (antioxidant).

Phytochemicals can be grouped into different classes based on structure as follows:

### Phenolic Compounds

Natural monophenols
   Apiole—parsley
   Carnosol—rosemary.
   Carvacrol—oregano, thyme.
   Dillapiole—dill.
   Rosemarinol—rosemary.
Flavonoids (polyphenols)—red, blue, purple pigments.
   lavonols
      Quercetin—red and yellow onions, tea, wine, apples, cranberries, buckwheat, beans.
      Gingerole—ginger.
      Kaempferol—strawberries, gooseberries, cranberries, peas, brassicates, chives.
      Myricetin—grapes, walnuts.
      Rutin—citrus fruits, buckwheat, parsley, tomato, apricot, rhubarb, tea, pagoda tree fruits.
      Isorhamnetin
   Flavanones
      Hesperidin—citrus fruits.
      Naringenin—citrus fruits.
      Silybin—blessed milk thistle.
      Eriodictyol
   Flavones
      Apigenin—chamomile, celery, parsley.
      Tangeritin—tangerine and other citrus peels.
      Luteolin
   Flavan-3-ols
      Catechins—white tea, green tea, black tea, grapes, wine, apple juice, cocoa, lentils, black-eyed peas.
      (+)-Catechin
      (+)-Gallocatechin
      (−)-Epicatechin
      (−)-Epigallocatechin
      (−)-Epigallocatechin gallate (EGCG)—green tea;
      (−)-Epicatechin 3-gallate
      Theaflavin—black tea.
      Theaflavin-3-gallate—black tea.
      Theaflavin-3′-gallate—black tea.
      Theaflavin-3,3′-digallate—black tea.
      Thearubigins
   Anthocyanins (flavonals) and Anthocyanidins—red wine, many red, purple or blue fruits and vegetables.
      Pelargonidin—bilberry, raspberry, strawberry.
      Peonidin—bilberry, blueberry, cherry, cranberry, peach.
      Cyanidin—red apple & pear, bilberry, blackberry, blueberry, cherry, cranberry, peach, plum, hawthorn, loganberry, cocoa.
      Delphinidin—bilberry, blueberry, eggplant.
      Malvidin—bilberry, blueberry.
      Petunidin
   Isoflavones (phytoestrogens)
      Daidzein (formononetin)—soy, alfalfa sprouts, red clover, chickpeas, peanuts, other legumes.
      Genistein (biochanin A)—soy, alfalfa sprouts, red clover, chickpeas, peanuts, other legumes.
      Glycitein—soy.
   Dihydroflavonols
   Chalconoids
   Cottinestans (phytoestrogens)
      Coumestrol—red clover, alfalfa sprouts, soy, peas, brussels sprouts.
Phenolic acids
   Ellagic acid—walnuts, strawberries, cranberries, blackberries, guava, grapes.
   Gallic acid—tea, mango, strawberries, rhubarb, soy.
   Salicylic acid—peppermint, licorice, peanut, wheat.
   Tannic acid—nettles, tea, berries.
   Vanillin—vanilla beans, cloves.
   Capsaicin—chili peppers.
   Curcumin—turmeric, mustard.
Hydroxycinnamic acids
   Caffeic acid—burdock, hawthorn, artichoke, pear, basil, thyme, oregano, apple.
   Chlorogenic acid—echinacea, strawberries, pineapple, coffee, sunflower, blueberries.
   Cinnamic acid—cinnamon, aloe.
   Ferulic acid—oats, rice, artichoke, orange, pineapple, apple, peanut.
   Coumarin—citrus fruits, maize.
Lignans (phytoestrogens)—seeds (flax, sesame, pumpkin, sunflower, poppy), whole grains (rye, oats, barley), bran (wheat, oat, rye), fruits (particularly berries) and vegetables.
   Silymarin—artichokes, milk thistle.
   Matairesinol—flax seed, sesame seed, rye bran and meal, oat bran, poppy seed, strawberries, blackcurrants, broccoli.
   Secoisolariciresinol—flax seeds, sunflower seeds, sesame seeds, pumpkin, strawberries, blueberries, cranberries, zucchini, blackcurrant, carrots.
   Pinoresinol and lariciresinol—sesame seed, Brassica vegetables.
Tyrosol esters
   Tyrosol—olive oil.
   Hydroxvoirosol—olive oil.
   Oleocanthal—olive oil.
   Oleuropein—olive oil.
Stilbenoids
   Resveratrol—grape skins and seeds, wine, nuts, peanuts.
   Pterostilbene—grapes, blueberries.
   Piceatannol—grapes.
Punicalagins—pomegranates.

### Terpenes (Isoprenoids)

Carotenoids (tetraterpenoids)
   Carotenes—orange pigments.
      α-Carotene—to vitamin A, in carrots, pumpkins, maize, tangerine, orange.
      β-Carotene—to vitamin A, in dark, leafy greens and red, orange and yellow fruits and vegetables.
      γ-Carotene
      δ-Carotene
      Lycopene—Vietnam Gac, tomatoes, grapefruit, watermelon, guava, apricots, carrots, autumn olive.
      Neurosporene
      Phytofluene—star fruit, sweet potato, orange.
      Phytoene—sweet potato, orange.
   Xanthophylls—yellow pigments.
      Canthaxanthin—paprika.
      Cryptoxanthin—mango, tangerine, orange, papaya, peaches, avocado, pea, grapefruit, kiwi.
      Zeaxanthin—wolfberry, spinach, kale, turnip greens, maize, eggs, red pepper, pumpkin, oranges.
      Astaxanthin—microalge, yeast, krill, shrimp, salmon, lobsters, and some crabs.
      Lutein—spinach, turnip greens, romaine lettuce, eggs, red pepper, pumpkin, mango, papaya, oranges, kiwi, peaches, squash, legumes, brassicates, prunes, sweet potatoes, honeydew melon, rhubarb, plum, avocado, pear.
      Rubixanthin—rose hips.
Monoterpenes
   Limonene—oils of citrus, cherries, spearmint, dill, garlic, celery, maize, rosemary, ginger, basil.
   Perillyl—alcohol citrus oils, caraway, mints.
Saponins—soybeans, beans, other legumes, maize, alfalfa.
Lipids
   Phytosterols—almonds, cashews, peanuts, sesame seeds, sunflower seeds, whole wheat, maize, soybeans, many vegetable oils.
      Campesterol—buckwheat.
      Beta Sitosterol—avocados, rice bran, wheat germ, corn oils, fennel, peanuts, soybeans, hawthorn, basil, buckwheat.
      Gamma Sitosterol
      Stigmasterol—buckwheat.
   Tocopherols (vitamin E)
   Omega-3, 6,9 fatty acids—dark-green leafy vegetables, grains, legumes, nuts.
      gamma-linolenic acid—evening primrose, borage, blackcurrant.
Triterpenoid
   Oleanolic acid—American pokeweed, honey mesquite, garlic, java apple, cloves, and many other Syzygium species.
   Ursolic acid—apples, basil, bilberries, cranberries, elder flower, peppermint, lavender, oregano, thyme, hawthorn, prunes.
   Betulinic acid—Ber tree, white birch, tropical carnivorous plants Triphyophyllum peltatum and Ancistrocladus lzeyneanus, Diospyros leucomelas a member of the persimmon family, Tetracera boiviniana, the jambul (Syzygium formosanum), and many. other Syzygium species.
   Moronic acid—Rhus javanica (a sumac), mistletoe

### Betalains

Betacyanins
   Betanin—beets, chard
   Isobetanin—beets, chard
   Probetanin—beets, chard
   Neobetanin—beets, chard
Betaxanthins (non glycosidic versions)
   Indicaxanthin—beets, sicilian prickly pear
   Vulgaxanthin—beets

### Organosulfides

Dithiolthiones (isothiocyanates)
   Sulphoraphane—Brassicates.
Thiosulphonates (allium compounds)
   AIlyl methyl trisulfide—garlic, onions, leeks, chives, shallots.
   Diallyl sulfide—garlic, onions, leeks, chives, shallots.

### Indoles, Glucosinolates/Sulfur Compounds

Indole-3-carbinol—cabbage, kale, brussels sprouts, rutabaga, mustard greens, broccoli.
Sulforaphane—broccoli
3,3′-Diindolylmethane or DIM—broccoli family
Sinigrin—broccoli family
Allicin—garlic
Alliin—garlic
Allyl isothiocyanate—horseradish, mustard, wasabi
Piperine—black pepper
Syn-propanethial-S-oxide—cut onions.

### Other Organic Acids

Oxalic acid—orange, spinach, rhubarb, tea and coffee, banana, ginger, almond, sweet potato, bell pepper.
Phytic acid (inositol hexaphosphate)—cereals, nuts, sesame seeds, soybeans, wheat, pumpkin, beans, almonds.
Tartaric acid—apricots, apples, sunflower, avocado, grapes.
Anacardic acid—cashews, mangoes.

The density (also referred to as concentration, and expressed as g/100 g, mg/kg or μg/g) of the phytochemicals in the foods listed above are available in the literature. Density can also be expressed as a numerical score relative to a given food with a known density of the phytochemical. Foods can also be ranked according to their phytochemical density.

Phytochemical density may also be expressed by assigning foods a set of internal weightings for all phytochemicals based on the percentage of the reference daily intake (RDI) found in a set serving size of the food. In order to determine RDI for a particular phytochemical, the U.S. Department of Agriculture (USDA) compiles nutrient data of foods based on a reference point of 100 grams of food. Therefore, for example, a weighting of 1 for lycopene may indicate that 100 grams of lycopene contains 100% of the RDI of lycopene. In other embodiments, the RDI can be calculated using a variety of alternative algorighms for determining phytochemical density.

Other Factors

In addition to phytochemical content and density, the methods and systems of the present invention can take into consideration other factors in the selection of foods, such as non-phytochemical based micronutrients such as vitamins and minerals, glycemic index, etc. Such other factors can be used to make a decision to include or exclude a food from the eating plan. For example, if the computer system determines that the subject has a high risk for developing diabetes, the food that is selected as being beneficial to the subject based on phytochemical content and density can be further refined by considering the glycemic index (from zero to 100) and eliminating food that has a glycemic index that is too high, such as over 60.

Accordingly, glycemic index alone can be incorporated into the method to put foods on an exclusion list based on glycemic index alone if the subject has diabetes or a risk of developing diabetes. Conversely, glycemic index can be used in conjunction with phytochemical content and density to tailor the list of foods included in the eating plan. For example, green apples and red apples have essentially the same phytochemical content and density, but green apples would be included on the list of foods in the eating plan because they have a lower glycemic index than red apples.

### Computer Implementation

In one embodiment, the method of the present invention is carried out on a computer that includes volatile and/or non-volatile storage media, a processor for manipulating data stored in the storage media, an input port for receiving data and an output port for transmitting data. The storage media of the computer may be preprogrammed with the following information: a list of phytochemicals that are known to be beneficial for treating the health condition; a list of foods known to contain the phytochemicals at a given density; and the density of those phytochemicals in the foods. The computer may be connected to a communications network such as a local area network or the internet in order to facilitate receiving and transmitting relevant data.

To implement the method of the present invention, the computer must be able to receive dynamic personal input, or “data” from a subject (either directly or indirectly as is the case when the personal eating plan is being implemented and managed by a health care professional), and the output such as the personal eating plan including a list of foods to include in the subject's diet must in some way be reflective of this input. In an entirely internet-based application of the method of the present invention, a subject accesses a centralized computer at a remote location over the internet, and inputs their data. Such access may be controlled by requiring a user name and password.

In one embodiment, the data obtained from the subject generally includes the information shown in Table I below.

TABLE I
Exemplary Subject Data

| Health | | | | |
|---|---|---|---|---|
| Conditions | Lifestyle | Eating Habits | Demographics | Biometrics |
| Diseases | Diet History | Weekly | Gender | Height & Weight |
| e.g. Diabetes, | | Consumption | | |
| Hypertension | | e.g. Personal, | | |
| | | Household | | |
| Chronic | Eating Out | Meats/Seafood | Age | Systolic |
| Conditions, e.g. | Breakfast/Wk. | | | |
| Allergies, | Lunch/Wk. | | | |
| Asthma | Dinner/Wk. | | | |
| Prescription | Type of | Dairy | Race | Diastolic |
| Medications | Restaurant | Consumption | | |
| e.g. Statins | | e.g. Eggs | | |
| | | Cheese, | | |
| | | Milk | | |
| Supplements | Exercise (how | Grain | Education | Glucose |
| e.g. Multi, | often) | | | |
| Omega, | e.g., Running, | | | |
| Flax | Walking, | | | |
| | Strength, | | | |
| | Cardio | | | |
| Weight Goals | Hours of Sleep | Fruit | Marital Status | LDL Cholesterol |
| | per Night | | | |
| Diet Goals | Travel & Work | Vegetables | Household Size | Triglycerides |
| | | Beans, Nuts, | Number of Kids | Vitamin D25 |
| | | Seeds | | |
| | | Snacks | Zip | Vitamin B12 |
| | | Dessert | Household | |
| | | | Income | |
| | | Juices & Drinks | | |
| | | Alcohol | | |

As shown, this data includes personal healthcare information, such as dietary information, current medications, preexisting health conditions such as obesity, diabetes or hypertension, and biometrics such as weight, body mass index, glucose level, etc. This data is then used by the computer to perform a “health risk assessment”, which means that the computer identifies the preexistence of one or more health conditions, as well as the risk (which may be ranked from low to high) that the subject will develop one or more health conditions in the future.

It should be understood that if the computer prompts the subject to answer questions based on the parameters shown in Table I, the subject may choose not to answer some or even most of the questions because they simply don't want to or they don't know the answers. The methods and systems of the present invention allow the subject to access their data more than once to change or update it. In addition, if the computer is unable to determine if the subject has a health condition or a risk of developing a health condition, it will generate an eating plan based on the identification of foods that are generally regarded as promoting good health based on their phytochemical content and density.

In addition to providing a subject with a personal eating plan including a list of foods to be ingested, in various embodiments, a “food exclusion list” is generated based on the data, and is provided as a list of foods to avoid eating. The food exclusion list is created based on various health conditions that the patient already has, or is at risk for developing, such as diabetes or hypertension. In this instance, the computer is preprogrammed with a list of foods to be avoided by subjects having a given health condition or conditions, or at risk for developing such health conditions.

In other embodiments of the present invention, the food is “weighted” based on its aggregate phytochemical content and density. For example, lycopene is beneficial in the treatment of heart disease and high blood pressure. Lycopene is found in tomatoes, which also contain relatively high levels of other phytochemicals that may not be associated with heart disease and high blood pressure. If the subject's data is analyzed and the computer determines that the subject is at high risk for heart disease, the lycopene density may be given a higher weighting than the other phytochemicals in both the inclusion of the tomato and the ranking of the tomato on the list of foods in the eating plan.

### Consumption Plans

In one embodiment, the method of the present invention is designed to provide a subject with a list of foods to consume in order to treat a health condition or minimize the risk of developing the health condition. This list of foods may be ranked, such that the best foods are identified along with the foods that are less than ideal, but still “good” to incorporate into the subject's personal eating plan. The subject can then decide on their own how much of these foods to eat and how to incorporate them into their diet.

In another embodiment of the present invention, the subject is provided with a list of foods in certain food groups, and information about serving sizes and how many servings per day/week the subject should consume based on their health condition assessment. Exemplary food groups and representative foods that belong in these groups are shown below in Table II.

TABLE II
Food Groups

| Cooked | Colorful | | | | Whole |
|---|---|---|---|---|---|
| Vegetables | Vegetables | Fruits | Beans | Nuts & Seeds | Grains |
| Onion | Fennel | Blackberries | Lentils | Sunflower | Quinoa |
| Zucchini | Leek | Strawberries | Adzuki | Sesame | Millett |
| Mushroom | Peppers | Blueberries | Edamame | Walnuts | Brown Rice |
| Egplant | Cauliflower | Oranges | Lima | Pistachio | Steel Cut |
| | | | | | Oats |
| Asparagus | Tomatoes | Kiwi | Black | | Wild Rice |
| Sweet Potato | Turnip | Green | | | |
| | | Applies | | | |
| | Cabbage | Avocado | | | |
| | | Peaches | | | |
| | | Plums | | | |
| | | Guava | | | |
| | | Grapefruit | | | |
| | | Elderberry | | | |
| | | Raspberry | | | |
| | | Watermelon | | | |
| | | Papaya | | | |

Furthermore, in another embodiment of the present invention, the method includes a consumption guide that identifies which foods should be eaten, how much to eat, and how often to eat them. As such, the method of the present invention can be utilized to provide a subject with a comprehensive nutrition program.

In other embodiments of the present invention, a customized nutrition program is implemented in a variety of different ways, such as over a set period of days e.g., a 30-day or 60-day program. Furthermore, a customized nutrition program can also be monitored and/or modified over time in order to adapt to changes in a subject's data and assessment of health conditions based on the data. Accordingly, it is contemplated in this disclosure that there are a variety of methods for implementing a customized nutrition program as described herein.

Servings

An exemplary nutrition program may suggest that the subject consume on any given day at least two servings of raw vegetables, one serving of cooked green vegetables, one serving of colorful vegetables; three servings of fruit, one to two servings of nuts/seeds, one serving of beans; no more than four servings of whole grains/starchy vegetables; and limited (less than daily) servings of fish, eggs, dairy, poultry/meat, white bread/pasta, oils, processed foods and sweets.

In further embodiments, the highest minimum serving count is determined by comparing the minimum serving guidelines of all seven food groups across all of a subject's conditions. For example, if a first condition requires a minimum of two servings of raw green leafy vegetables, and a second condition requires a minimum of four servings of raw green leafy vegetables, then the subject's required minimum serving of raw green leafy vegetables would be four servings.

Some health conditions may have negative factors pertaining to certain food groups. For example, if a subject has a health condition that dictates a maximum daily serving limit, the maximum daily serving limit for the food group with the negative factor is used for the subject's required maximum serving of a particular food group, instead of providing a required minimum serving of that food group. Thus, the minimum or maximum serving guidelines can be adjusted as needed depending on the subject's specific needs. In one embodiment, both the minimum and maximum serving values are combined to create a subject's nutrition program.

An example of serving guidelines is shown below in Table III, wherein servings have been optimized for a subject having a high risk for cancer and a medium risk for hypertension:

TABLE III
Exemplary Serving Guidelines

| | Cancer - | Hypertension - | |
|---|---|---|---|
| | High | Medium | Minimum |
| | Servings | Servings | Servings |
| Raw Green Leafy | 4 | 3 | 4 |
| Vegetables (RGLV) | | | |
| Cooked Green Leafy | 3 | 2 | 3 |
| Vegetables (CGLV) | | | |
| Colorful Vegetables | 3 | 2 | 3 |
| (CV) | | | |
| Fruit (FR) | 4 | 3 | 4 |
| Beans (BN) | 3 | 2 | 3 |
| Nuts/Seeds (NS) | 1 | 1 | 1 |
| Grains (GS) | 2 | 1 | 2 |

### Recipes

In yet another embodiment, the method of the present invention can include the step of providing recipes for use in preparing the list of foods to be consumed according to the nutrition program. The recipes may be categorized in various ways depending on the desired format. For example, recipes can be categorized based on meal setting i.e., breakfast, lunch and dinner. Alternatively, recipes can be categorized according to seven different food groups comprised of raw green leafy vegetables, cooked green leafy vegetables, colorful vegetables, fruit, beans, nuts and seeds, and grains. In yet other embodiments, the recipes may be categorized according to region/ethnicity, allergies/dietary restrictions or lifestyle choices (e.g. vegetarian/vegan, etc.).

In various embodiments, the list of recipes may further be modified based on any exclusions that appear on the food exclusion list. For example, carrots can be excluded from the list of recipes for a patient afflicted with diabetes. As such, recipes featuring ingredients such as carrot juice can be removed from a subject's list of recipes. Alternatively, some ingredients may be substituted for and replaced with other ingredients to achieve the same goal. For example, carrots can be replaced with kale in a variety of recipes. Furthermore, some recipes can be designed to contain a large number of possible ingredients in order to provide additional variety for the subject.

Based on the list of recipes, a customized meal plan can be created that provides the subject with optimal health benefits to treat a health condition or minimize the risk of developing a health condition. An exemplary meal plan is shown below, wherein the recipes have been categorized according to meal setting:

Breakfast
Main Course (select one):
   Cinnamon Fruit Oatmeal
   Fruit and berries with plain or vanilla non-fat yogurt
   Grapefruit
   Whole-grain toast
Beverages (select one):
   Orange Juice
   Pomegranate juice
   Carrot Juice

Lunch
Main Course (select one):
   Whole Wheat Pita Wrap
   Orange Sesame Tossed Salad
   Fast Black Bean Soup
Side Dish (se)ect one):
   Orange
   Raw Vegetables

Dinner
Main Course (select one):
   Chunky Sweet Potato Stew
   Pasta with Roasted Vegetables
   Simple Bean Burgers
Side Dish:
   Braised Bok Choy
   Raw vegetables
   Tasty Hummus
   Hot Pepper Salsa
   Baked Garlic Pita Chips
   Sunshine Slaw
Dessert:
   Poached Pears with Raspberry Sauce
   Wild Apple Crunch
   Very Berry Ice Cream
   Sliced watermelon

### Health Conditions

Many health conditions are severely impacted by diet. Accordingly, the methods and systems of the present invention are particularly well suited in the treatment of these health conditions and lessening the risk of suffering from these health conditions in the future. These health conditions include, for example, obesity, hypertension and diabetes.

The disclosure set forth above is provided to give those of ordinary skill in the art with a complete disclosure and description of how to make and use various embodiments of the invention, and are not intended to limit the scope of what the inventors regard as their invention. Modifications of the above-described modes (for carrying out the invention that are obvious to persons of skill in the art) are intended to be within the scope of the following claims. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention. All publications, patents, and patent applications cited in this specification are incorporated herein by reference as if each such publication, patent or patent application were specifically and individually indicated to he incorporated herein by reference.

What is claimed is:

1. A computer-implemented method for preparing a health condition-specific personal eating plan for a subject based on phytochemical content and density of foods, the method comprising the steps of:
preprogramming the computer with:
a list of phytochemicals that are known to be beneficial for treating the health condition;
a list of foods known to contain the phytochemicals at a given density;
and
the density of those phytochemicals in the foods;
obtaining data from the subject, wherein the data comprises personal healthcare information and eating behaviors;
processing the data to determine if the subject has one or more existing health conditions or a risk for developing one or more health conditions; and
generating a health condition-specific list of foods to incorporate into the subject's personal eating plan that is customized for the subject based on their health condition or conditions, or risk of developing the health condition or conditions;
wherein the health condition-specific list of foods is based on the phytochemical content and density of the foods.

2. The method according to claim 1, wherein the food is unprocessed plant-based food.

3. The method according to claim 1, wherein the foods are selected for the list of foods without considering their caloric value.

4. The method according to claim 1, wherein the subject's risk of developing the health condition is ranked.

5. The method according to claim 4, wherein the ranking is low, medium or high.

6. The method according to claim 1, wherein the foods on the list of foods are ranked.

7. The method according to claim 6, wherein the ranking is in order of the phytochemical density of the foods.

8. The method according to claim 1, further comprising generating the list of foods based on glycemic index of the food.

9. The method according to claim 1, wherein the list of foods is categorized into food groups.

10. The method according to claim 1, wherein the food groups comprise comprise cooked vegetables, colorful vegetables, fruits, nuts & seeds, beans, and whole grains & starchy vegetables.

11. The method according to claim 1, wherein the list of foods further comprises portion sizes for each of the foods on the list.

12. The method according to claim 9, further comprising generating a daily or weekly intake plan for the subject that includes serving numbers to ingest in each food groups.

13. The method according to claim 1, further comprising generating a list of recipes that include the foods on the list of foods.

14. A method for preparing a health condition-specific personal eating plan for a subject based on phytochemical content and density of foods, the method comprising the steps of:
providing the subject with a list of phytochemicals that are known to be beneficial for treating the health condition;
providing the subject with a list of foods known to contain the phytochemicals at a given density;
analyzing personal healthcare information and eating behaviors of the subject to determine if the subject has one or more existing health conditions or a risk for developing one or more health conditions; and
generating a health condition-specific list of foods to incorporate into the subject's personal eating plan that is customized for the subject based on their health condition or conditions, or risk of developing the health condition or conditions; and
the subject consuming at least one food on the health condition-specific list of foods;
wherein the health condition-specific list of foods is based on the phytochemical content and density of the foods.
